(19) United States
(12) Patent Application Publication
(10) Pub. No.: US 2018/0299102 A1
(43) Pub. Date: Oct. 18, 2018

(54) WAVELENGTH CONVERSION FILM

(71) Applicant: FUJIFILM Corporation, Tokyo (JP)

(72) Inventors: Natsuru CHIKUSHI, Kanagawa (JP); Tatsuya OBA, Kanagawa (JP)

(73) Assignee: FUJIFILM Corporation, Tokyo (JP)

(21) Appl. No.: 16/012,363

(22) Filed: Jun. 19, 2018

Related U.S. Application Data
(63) Continuation of application No. PCT/JP2016/088515, filed on Dec. 22, 2016.

(30) Foreign Application Priority Data
Dec. 22, 2015 (JP) 2015-250589

(51) Int. Cl. F21V 9/30; B32B 7/02; B32B 9/04; G02B 1/14

(52) U.S. Cl. CPC F21V 9/30; B32B 7/02; B32B 9/045; B32B 2250/40; B32B 2307/7246; B32B 2307/40; B32B 2250/03; G02B 1/14

(57) ABSTRACT

An object of the present invention is to provide a wavelength conversion film having excellent durability. The problem is solved by providing a wavelength conversion film including: a wavelength conversion layer and base materials sandwiching the wavelength conversion layer therebetween; and a welded portion in which the base materials are welded to each other on an outer side in a surface direction of the wavelength conversion layer, in which the base materials have a support having a vapor permeability less than or equal to 10 g/(m²·day) and a first organic layer, which is formed on one surface side of the support and formed of polyvinyl alcohol or a polyvinyl alcohol copolymer, and have the wavelength conversion layer sandwiched therebetween while the support faces outward.

### CROSS-REFERENCE TO RELATED APPLICATIONS

This application is a Continuation of PCT International Application No. PCT/JP2016/088515 filed on Dec. 22, 2016, which claims priority under 35 U.S.C. § 119(a) to Japanese Patent Application No. 2015-250589 filed on Dec. 22, 2015. The above application is hereby expressly incorporated by reference, in its entirety, into the present application.

### BACKGROUND OF THE INVENTION

### 1. Field of the Invention

The present invention relates to a wavelength conversion film. In particular, it relates to a wavelength conversion film containing a material of which performance easily deteriorates due to oxygen or the like.

### 2. Description of the Related Art

In the flat panel display market, improvement in color reproducibility has progressed as improvement of performance of a liquid crystal display (LCD) and various techniques of improving color reproducibility have been proposed.

Among these, a luminescent material called a quantum dot in which a quantum restriction effect is utilized is widely used as a material for improving color reproducibility, because of advantages such as high fluorescence quantum efficiency and a narrow half-width of a fluorescence spectrum. More specifically, it is possible to provide a light source suitable for full color display with high color reproducibility by providing a fluorescent material such as a quantum dot or the like, as a member constituting the backlight unit, in a sheet shape or a strip shape on an optical path and irradiating the fluorescent material with excitation light (for example, blue light or ultraviolet light). In this specification, the fluorescent material such as a quantum dot provided in a sheet shape or a strip shape is called a wavelength conversion film.

However, it is known that various kinds of phosphors including quantum dots which are suitable for display applications deteriorate due to light irradiation for a long period of time in the presence of oxygen or water, thereby impairing fluorescence characteristics. Due to deterioration of the phosphors, the display performance, such as color reproducibility or tone, of a display deteriorates. For this reason, the wavelength conversion film preferably has a structure in which a phosphor or a material carrying a phosphor is coated with a member that protects the phosphor or the material carrying a phosphor from oxygen or water.

Specifically, JP2013-47324A discloses a technique of sealing a fluorescent layer sandwiched between transparent supports with a sealing film. In addition, JP2010-258469A discloses a technique of directly sealing a material containing a phosphor with a sealing film.

### SUMMARY OF THE INVENTION

However, there is a problem in JP2013-47324A that the thickness of the wavelength conversion film becomes excessively thick since the sealing film is provided separately from the support. In response to the problem, it is considered that a material to which a transparent barrier layer with an inorganic layer is attached is used for reducing the thickness of the sealing film. However, various kinds of inorganic thin film materials used as the transparent barrier layer have deteriorated gas barrier properties since these are easily damaged through bending or compression. Therefore, in a case where joining of end portions is performed in a form as disclosed in JP2013-47324A, there is a problem in that oxygen or vapor infiltrates through a bent portion or an adhesive portion.

In addition, although it is possible to overcome the problem of thickness in JP2010-258469A since the support and the sealing material are integrated, the same problem as described above remains in the sealing of the end portions.

That is, an object of the present invention is to provide a wavelength conversion film which has suitable sealing performance while being thin and has a sealing structure having excellent blocking properties against oxygen or vapor on not only the main surfaces but also the end portions.

The inventors have studied the structure of a thin wavelength conversion film which has excellent durability and exhibits favorable sealing performance at end portions even after undergoing a pressure-bonding step or the like, by applying polyvinyl alcohol and a copolymer thereof as a barrier material. It is known that polyvinyl alcohol and a copolymer thereof gradually lose sealing performance under high temperature and high humidity conditions over a long period of time. However, as a result of the extensive studies, the inventors have realized a wavelength conversion film maintaining favorable sealing performance over a long period of time by having a structure described below.

That is, the wavelength conversion film of the present invention is a wavelength conversion film comprising: a wavelength conversion layer and base materials sandwiching the wavelength conversion layer therebetween; and a welded portion in which the base materials are welded to each other on an outer side in a surface direction of the wavelength conversion layer, in which the base materials have a support having a vapor permeability less than or equal to 10 g/(m²·day) and a first organic layer, which is formed on one surface side of the support and formed of polyvinyl alcohol or a polyvinyl alcohol copolymer, and have the wavelength conversion layer sandwiched therebetween while the support faces outward.

In such a wavelength conversion film of the present invention, it is preferable that the base materials have a second organic layer having a vapor permeability less than or equal to 30 g/(m²·day), and the support, the second organic layer, and the first organic layer are laminated in this order.

In addition, it is preferable that the support includes a vapor barrier layer having a vapor permeability less than or equal to 10 g/(m²·day).

In addition, it is preferable that an oxygen permeability of the first organic layer is less than or equal to 10 cc/(m²·day·atm) at the innermost position of the welded portion in the surface direction of the wavelength conversion layer.

In addition, it is preferable that the vapor permeability of the vapor barrier layer is less than or equal to 30 g/(m²·day) at the innermost position of the welded portion in the surface direction of the wavelength conversion layer.

In addition, it is preferable that a thickness of the first organic layer in a region of the welded portion is less than or equal to 50% of the thickness of the first organic layer in a region of a main surface.

Furthermore, it is preferable that a space between the base materials sandwiching the wavelength conversion layer therebetween is filled with the wavelength conversion layer.

According to the configuration of the present invention, it is possible to obtain a satisfactory end portion-sealed structure without deterioration of the gas barrier properties at end portions even by adhesion of the end portions. In addition, a problem such as humidity durability which is a disadvantage of polyvinyl alcohol and a copolymer thereof is overcome by suppressing infiltration of moisture that causes deterioration in a layer of polyvinyl alcohol and a copolymer thereof which has gas barrier properties, in particular, oxygen barrier properties.

### BRIEF DESCRIPTION OF THE DRAWINGS

FIG. 1 is a view conceptually showing an example of a wavelength conversion film of the present invention.

FIG. 2 is a view conceptually showing another example of a wavelength conversion film of the present invention.

FIG. 3 is a view in a case where still another example of a wavelength conversion film of the present invention is seen from above.

FIG. 4 shows a view in a case where still another example of a wavelength conversion film of the present invention is seen from above, and a cross-sectional view taken along a broken line.

FIG. 5 is a view in which a shape of an end portion of an example of a wavelength conversion film of the present invention is enlarged.

FIG. 6 is a view schematically showing a method for manufacturing a wavelength conversion film of the present invention.

### DESCRIPTION OF THE PREFERRED EMBODIMENTS

Hereinafter, a wavelength conversion film according to the present invention will be described with reference to the accompanying drawings.

In the present specification, “to” means a range including numerical values denoted before and after “to” as a lower limit value and an upper limit value.

{Wavelength Conversion Film}

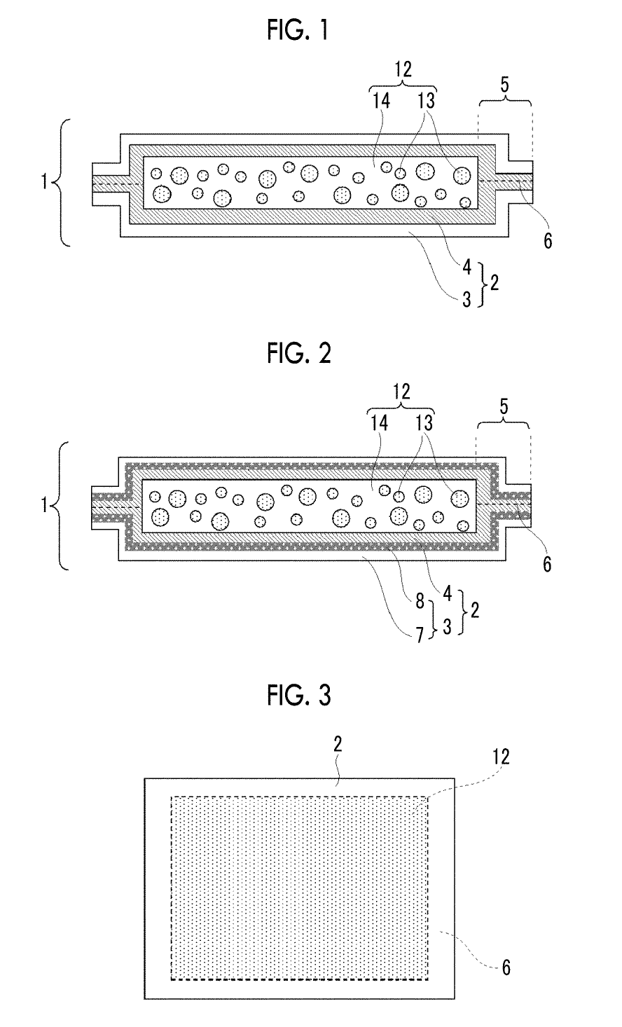

A wavelength conversion film 1 of the present invention exemplified in FIG. 1 has a wavelength conversion layer 12 and base materials 2 sandwiching the wavelength conversion layer 12 therebetween, and has a characteristic in that the base materials 2 are welded to each other in an outer region 5 in a surface direction of the wavelength conversion layer 12.

As described above, the wavelength conversion film is a member that emits light having a wavelength different from that of excitation light using a phosphor contained in the member which emits fluorescence, phosphorescence, or the like due to incidence of the excitation light. The wavelength conversion film is composed of a wavelength conversion layer containing a phosphor, a base material, and other functional layers. The wavelength conversion film can have a shape such as a rectangular shape, a circular shape, or a strip shape according to the application. It is preferable that the wavelength conversion film has flexibility. It is also preferable that there is no change in performance or appearance before and after being wound around an 8 mm mandrel.

In the following description, fluorescence and phosphorescence are collectively referred to as photoluminescence.

[Wavelength Conversion Layer]

In the present invention, the wavelength conversion layer 12 is preferably a fluorescent layer obtained by dispersing a large number of phosphors in a matrix 14 such as a resin, and is a layer in which the phosphors contained in a member emits photoluminescence, which is light having a wavelength different from that of excitation light, due to light incident on the wavelength conversion layer. In the wavelength conversion film 1 of the illustrated example, as a more preferred embodiment, the wavelength conversion layer 12 is a quantum dot layer obtained by dispersing quantum dots 13 in a binder which becomes the matrix 14.

<Quantum Dots and Quantum Rods>

Quantum dots are fine particles of a compound semiconductor having sizes of several nanometers to several tens of nanometers, and emit fluorescence by being excited by at least incident excitation light.

The quantum dots included in the wavelength conversion layer 12 can include at least one kind of quantum dot or two or more kinds of quantum dots having different light emission characteristics. As well-known quantum dots, there are quantum dots (A) having an emission center wavelength in a wavelength range within a range of greater than 600 nm and less than or equal to 680 nm, quantum dots (B) having an emission center wavelength in a wavelength range within a range of greater than 500 nm and less than or equal to 600 nm, and quantum dots (C) having an emission center wavelength in a wavelength range of 400 to 500 nm. The quantum dots (A) are excited by excitation light to emit red light, the quantum dots (B) emit green light, and the quantum dots (C) emit blue light.

For example, in a case where blue light is made incident on the wavelength conversion layer 12, including the quantum dots (A) and quantum dots (B), as excitation light, it is possible to realize white light using the red light emitted by the quantum dots (A), the green light emitted by the quantum dots (B), and the blue light transmitted through the wavelength conversion layer. Alternately, it is possible to realize white light using the red light emitted by the quantum dots (A), the green light emitted by the quantum dots (B), and the blue light emitted by the quantum dots (C) by making ultraviolet light incident on the wavelength conversion film, which has the wavelength conversion layer 12 including the quantum dots (A) to (C), as excitation light.

It is possible to refer to, for example, paragraphs 0060 to 0066 of JP2012-169271A for the quantum dots, but the present invention is not limited to those described herein. Commercially available products can be used as the quantum dots without any limitation. The emission wavelengths of the quantum dots can usually be adjusted by the composition and size of particles.

The wavelength conversion layer (quantum dot layer) 12 is preferably formed using a polymerizable composition (coating solution) in which the quantum dots 13 are dispersed. The content of the quantum dots 13 may be appropriately set according to the types of the quantum dots 13, the performance required for the wavelength conversion film 1, and the like. Specifically, the quantum dots 13 can be added, for example, in an amount of about 0.1 to 10 parts by mass with respect to 100 parts by mass of the total amount of the polymerizable composition.

The quantum dots 13 may be added to the polymerizable composition in a state of particles or in a state of a dispersion liquid in which the quantum dots are dispersed in an organic solvent. It is preferable to add the quantum dots in the state of the dispersion liquid from the viewpoint of suppressing aggregation of particles of the quantum dots 13. The organic solvent used for dispersing the quantum dots 13 is not particularly limited.

In the present invention, quantum rods can be used instead of the quantum dots 13. The quantum rods are elongated rod-shape particles and have properties similar to those of the quantum dots. The addition amount of the quantum rods can be set the same as that of the quantum dots and the method for adding quantum rods to a polymerizable composition can be carried out through the same method as the method for adding quantum dots to a polymerizable composition. In addition, in the present invention, quantum dots and quantum rods can also be used in combination.

<Matrix>

As described above, the wavelength conversion layer 12 is preferably obtained by dispersing the quantum dots 13 in the matrix 14 made of a cured resin or the like. Such a wavelength conversion layer 12 can be formed using a polymerizable composition in which the quantum dots 13 are dispersed. Accordingly, the polymerizable composition can contain a polymerizable compound (curable compound) which becomes a resin (binder) forming the matrix 14 in the wavelength conversion layer 12.

In the present invention, one having a polymerizable group can be widely employed as the polymerizable compound forming the wavelength conversion layer 12. Although the type of the polymerizable group is not particularly limited, a (meth)acrylate group, a vinyl group, or an epoxy group is preferable, a (meth)acrylate group is more preferable, and an acrylate group is still more preferable. In addition, the polymerizable compound having two or more polymerizable groups may have the same or different polymerizable groups.

It is possible to add a polymerization initiator corresponding to the polymerizable compound to the wavelength conversion layer (polymerizable composition) 12 as necessary. The polymerization initiator can be selected from a photopolymerization initiator or a thermal polymerization initiator.

It is possible to further add other additives to the wavelength conversion layer (polymerizable composition) 12 as necessary. Specific examples of the other additives include a thixotropic agent, an adhesion improver for improving adhesion to an adjacent layer, an antioxidant, a radical scavenger, an oxygen remover (oxygen getter agent), a moisture remover (moisture getter agent), a colorant, a plasticizer, and a light scattering agent.

The thickness of the wavelength conversion layer 12 can be appropriately set according to the desired luminance or chromaticity of emitted light. In particular, in a case where the quantum dots or the quantum rods are used, the thickness of the wavelength conversion layer can be appropriately set depending on the intensity and wavelength of incident excitation light, the correlation between the concentration of the quantum dots or quantum rods to be used and the apparent emission quantum efficiency, and an optical system to be incorporated. Typically, the thickness of the wavelength conversion layer 12, that is, the quantum dot layer is preferably 10 to 3,000 μm, more preferably 20 to 1,000 μm, and particularly preferably 30 to 500 μm.

[Base Material]

The base materials 2 in the wavelength conversion film of the present invention provide shape stability of the wavelength conversion film 1 by sandwiching the wavelength conversion layer 12 therebetween, and have a function of coating at least a region of the surface of the wavelength conversion layer 12 to physically and chemically protect the wavelength conversion layer. The base materials 2 in the present invention have a support 3 and a first organic layer 4 which is formed on one surface side of the support and made of polyvinyl alcohol or a polyvinyl alcohol copolymer. In addition, the support 3 has a vapor permeability of less than or equal to 10 g/(m²·day).

In the present invention, the vapor permeability may be measured, for example, through a MOCON method under the conditions of a temperature of 40° C. and a relative humidity of 90% RH. In addition, in a case where the vapor permeability exceeds a measurement limit of the MOCON method, the vapor permeability may be measured through a calcium corrosion method (the method disclosed in JP2005-283561A) under the same conditions. In addition, in the present invention, the oxygen permeability may be measured, for example, under the conditions of a temperature of 25° C. and a humidity of 60% RH using a measuring device (manufactured by NIPPON API CO., LTD.) based on an atmospheric pressure ionization mass spectrometry (APIMS) method.

<Support>

The support 3 of the wavelength conversion film 1 of the present invention has a vapor permeability of less than or equal to 10 g/(m²·day). Various polymer materials (resin materials or polymer material) can be used as the material forming such a support 3. Examples of the polymer material include polyolefins, cyclic polyolefins, halogenated polyolefins, polyvinyl alcohols, an acrylic resin, a styrene resin, a polyester resin, a polycarbonate resin, a polyamide resin, a polyimide resin, a cellulose resin, an acetal resin, a polyarylate resin, an epoxy resin, a silicone resin, and a copolymer or a polymer alloy thereof. The polymer material is not limited to a thermoplastic resin, and a cured product of a photocurable resin, a thermosetting resin, and a humidity-curable resin may be used as a support.

Since the wavelength conversion film 1 of the present invention is used, for example, in a light source device, the wavelength conversion film preferably has a small light absorption property. For example, the wavelength conversion film 1 of the present invention preferably has a total light transmittance of greater than or equal to 80% and more preferably has a total light transmittance of greater than or equal to 90%.

(Vapor Barrier Layer)

As shown in FIG. 2, it is possible to make the support 3 have a configuration including a vapor barrier layer 8. Specifically, the support 3 preferably includes an inorganic layer having a vapor permeability less than or equal to 10 g/(m²·day) as the vapor barrier layer 8. The transparent inorganic material forming the inorganic layer is not particularly limited, but examples thereof include metal or various inorganic compounds such as inorganic oxide, nitride, and oxynitride.

In the case where the support 3 has the vapor barrier layer 8, the support 3 may have a configuration in which, for example, the vapor barrier layer 8 is formed on a resin layer 7 made of a polymer material previously exemplified as the material forming the support 3, as shown in FIG. 2.

In a case where the vapor barrier layer 8 is formed on the resin layer 7 forming the support 3, an undercoat layer can also be provided from the viewpoint of improving adhesiveness.

A curable compound can be used as the undercoat layer. For example, a monomer having two or more ethylenically unsaturated groups is preferable. Examples of the monomer include esters of polyhydric alcohol with (meth)acrylic acid (for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, and polyester polyacrylate), vinylbenzene and a derivative thereof (for example, 1,4-divinylbenzene, 4-vinylbenzoic acid-2-acryloylethyl ester, and 1,4-divinylcyclohexanone), vinyl sulfone (for example, divinyl sulfone), (meth)acrylamide (for example, methylene bisacrylamide). Commercially available multifunctional acrylate compounds having a (meth)acryloyl group can also be used, and examples thereof include KAYARAD DPHA and KAYARAD PET-30 manufactured by Nippon Kayaku Co., Ltd., NK ESTER A-TMMT and NK ESTER A-TMPT (manufactured by SHIN-NAKAMURA CHEMICAL CO., LTD.)

From the viewpoint of reducing curing shrinkage and suppressing curling, it is preferable to add ethylene oxide, propylene oxide, or caprolactone to increase the distance between crosslinking points. For example, ethylene oxide-added trimethylolpropane triacrylate (for example, VISCOAT V#360 manufactured by OSAKA ORGANIC CHEMICAL INDUSTRY LTD.), glycerin propylene oxide-added triacrylate (for example, V#GPT manufactured by OSAKA ORGANIC CHEMICAL INDUSTRY LTD.), and caprolactone-added dipentaerythritol hexaacrylate (for example, DPCA-20 and DPCA-120 manufactured by Nippon Kayaku Co., Ltd.) are preferably used. It is also preferable to use two or more monomers having 2 or more ethylenically unsaturated groups in combination.

<First Organic Layer>

In the present invention, the first organic layer 4 is provided on one surface side of the support. The first organic layer 4 includes polyvinyl alcohol or a polyvinyl alcohol copolymer layer. Examples of the polyvinyl alcohol or the polyvinyl alcohol copolymer include polyvinyl alcohol resins with various saponification degrees, polyvinyl alcohol or a polyvinyl alcohol copolymer which is partially acetalized, esterified, or etherified, a copolymer with ethylene (ethylene vinyl alcohol (EVOH)), and a copolymer with (meth)acrylic acid or acrylonitrile. A polymer alloy obtained by further adding the above-described organic resins may be used. In addition, other additives can be added as necessary. Examples thereof include a plasticizer, an antioxidant, a fluorescent agent, a UV agent, a light scattering agent, and a crosslinking agent.

The oxygen permeability of the first organic layer 4 is preferably less than or equal to 10 cc/(m²·day·atm), more preferably less than or equal to 1×10⁻¹ cc/(m²·day·atm), and particularly preferably less than or equal to 1×10′ cc/(m²·day·atm).

<Second Organic Layer>

In the present invention, the base material may have a second organic layer. The second organic layer is further provided between the support 3 and the first organic layer 4 provided on one surface side of the support.

The first organic layer 4 is required to have low oxygen permeability. However, in a case where it is desired to further lower the vapor permeability, it is preferable to provide the second organic layer. Accordingly, the second organic layer preferably has low vapor permeability. The vapor permeability of the second organic layer is preferably less than or equal to 30 cc/(m²·day·atm) and more preferably less than or equal to 20 cc/(m²·day·atm).

Examples of the material contained in the second organic layer include polyolefins, cyclic polyolefins, halogenated polyolefins, a styrene resin, an epoxy resin, a silicone resin, and a copolymer or a polymer alloy thereof.

(Thickness of Support, First Organic Layer, and Second Organic Layer)

The thickness of the support 3 is preferably 10 to 200 μm and more preferably 12 to 100 μm. By setting the thickness of the support 3 within the range, it is possible to provide a flat base material without wrinkling or curling even in a case where first organic layers or even second organic layers are laminated.

The thicknesses of the first and second organic layers are preferably 3 to 50 μm. In a case where the thicknesses of the first and second organic layers are within the range, there is no concern of pinholes in the first and the second organic layers, and a thin wavelength conversion film can be realized.

The thickness of the inorganic layer used as the vapor barrier layer 8 is preferably 5 to 200 nm and more preferably 15 to 100 nm. In a case where the thickness of the inorganic layer is within the range, there is no concern of minute defects of the inorganic layer, and cracking due to internal stress of the inorganic layer or brittle fracture against bending of the wavelength conversion film can be prevented in advance.

<Method for Manufacturing Base Material>

Various well-known manufacturing methods can be used for the method for manufacturing the base materials 2.

Examples of the method for manufacturing a laminate with a plurality of layers include a method for simultaneously forming a laminated structure at the time of primary molding such as co-extrusion or co-casting, a method for laminating various layers, which have been separately molded, through thermal fusion welding, pressure-bonding, joining using an adhesive, and the like, and a method, such as an insert molding or coating method and a melt flow method, for further laminating and forming an organic resin layer on another organic resin layer which has been previously molded. The method for manufacturing the base materials 2 is not limited thereto, and an appropriate manufacturing method can be selected according to the properties of the raw material and the required shape.

In addition, a vapor phase film formation method such as a vapor deposition method or a sputtering method, and a film formation method from a solution such as polysilazane or alkoxysilane can be suitably used as a film formation method of inorganic layers. It is also possible to modify the inorganic layers through heating, UV irradiation, and the like.

[Sealing Structure of End Portion]

The wavelength conversion film 1 of the present invention has the wavelength conversion layer 12 sandwiched between the base materials 2 while the support 3 faces outward and has a characteristic in that the base materials are welded to each other in the outer region 5 in the surface direction of the wavelength conversion layer 12.

The welding referred to herein indicates a state in which the base materials come into direct contact with each other and are bonded without sandwiching an adhesive layer provided separately from the base materials. In the welded portion, it is preferable that the layers are integrated with each other through welding, and the interface optically and chemically disappears. However, there is no problem even in a case where the interface of both layers is optically and chemically observed as long as the welded portion has a sufficient peeling adhesive strength to the extent that peeling is not caused by ordinary use. The preferred peeling adhesive strength is preferably greater than or equal to 0.4 N/10 mm or more and more preferably greater than or equal to 0.5 N/10 mm.

In the wavelength conversion film 1 of the present invention, the entirety of the wavelength conversion layer is preferably sealed from the outside by sealing a main surface using the base materials 2 and sealing the outer side of the wavelength conversion layer in the surface direction using a region 6 (also referred to as a welded portion 6 in the present invention) in which the base materials 2 are welded.

An example of an embodiment includes a structure in which a pair of base materials 2 seal upper and lower main surfaces of a rectangular film-shaped wavelength conversion layer 12 as shown in FIG. 3 and outer four sides of the wavelength conversion layer 12 in the surface direction are sealed with the welded portion 6. Since a cross-sectional view thereof is similar to that of FIG. 1 or 2, it will not be repeated. FIG. 3 is a top view of the wavelength conversion film.

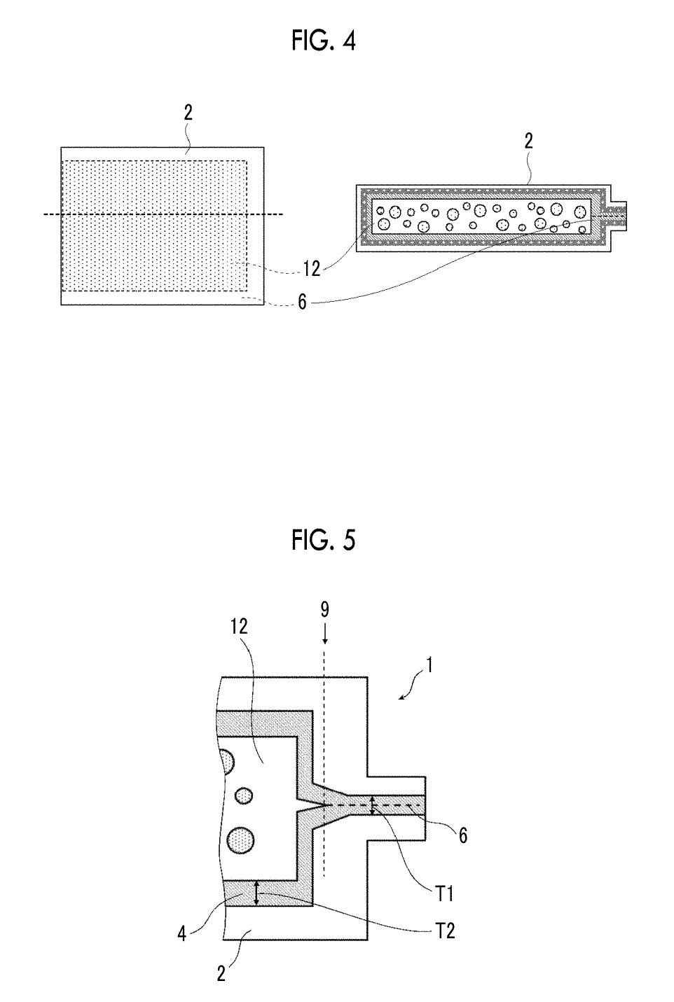

In addition, as shown in FIG. 4, a structure is also exemplified in which the upper and lower main surfaces of the rectangular film-shaped wavelength conversion layer 12 and an outer side in the surface direction of the wavelength conversion layer are sealed by folding a single continuous base material 2, and the remaining three outer sides in the surface direction of the wavelength conversion layer 12 are sealed with the welded portion 6. In FIG. 4, the left side is a top view of the wavelength conversion film and the right side is a cross-sectional view in a broken line shown in the wavelength conversion layer 12 in the top view.

In the welded portion 6, the base material is deformed by heat and pressure, and the gas barrier properties and the vapor barrier properties change. In the present invention, it is preferable that the vicinity of the welded portion 6 is also configured to maintain the gas barrier properties and the vapor barrier properties in order to provide a wavelength conversion film having favorable durability even at end portions.

Specifically, it is preferable that the oxygen permeability of the first organic layer 4 is less than or equal to 10 cc/(m²·day·atm) at the innermost position 9 of the welded portion 6 (the region 6 in which the base materials 2 are welded) in the surface direction of the wavelength conversion layer 12, as shown in FIG. 5.

In addition, in a case where the base materials have a second organic layer, it is preferable that the vapor permeability of the second organic layer is less than or equal to 30 g/(m²·day) at the innermost position 9 of the welded portion 6 in the surface direction of the wavelength conversion layer 12.

It is possible to measure the oxygen permeability and the vapor permeability of a corresponding area by cutting out a target wavelength conversion film. However, the measurement may be alternatively carried out through a method for calculating the vapor permeability and the oxygen permeability at a corresponding position using values obtained by separately measuring the vapor permeability and the oxygen permeability per unit thickness of a material used as functions of the film thickness by measuring the thickness of each of the first organic layer 4, the support 3, or the vapor barrier organic layer forming the support 3 through observation of the cross section at a corresponding position.

As a preferred embodiment of the present invention, the thickness T1 of the region in which the base materials 2 are welded to each other in the first organic layer 4 is less than or equal to 50% of the thickness T2 of the main surface region. As described above, the first organic layer 4 has inferior durability against vapor due to the characteristics of its material. Therefore, there is a concern that the exposed portion on the side surface which has not been covered with the support 3 may deteriorate under high temperature and high humidity conditions. On the contrary, the surface area of the first organic layer 4 exposed to the outside is reduced by setting the thickness of the first organic layer 4 as described above, and therefore, it is possible to realize an end portion-sealed structure having excellent durability.

In the present invention, the “main surface region” is a region of the wavelength conversion layer 12, that is, an inner region than the outer region 5 in the surface direction of the above-described wavelength conversion layer 12.

Furthermore, regarding the region in which the base materials 2 are welded to each other, it is possible to appropriately adjust the width in a vertical direction from an end surface, the shape of the wavelength conversion film at a corner portion, the cross-sectional thickness of each layer of the welded portion, and the like.

[Method for Sealing End Portion]

Various manufacturing methods can be applied as a manufacturing method for obtaining the wavelength conversion film 1 of the present invention.

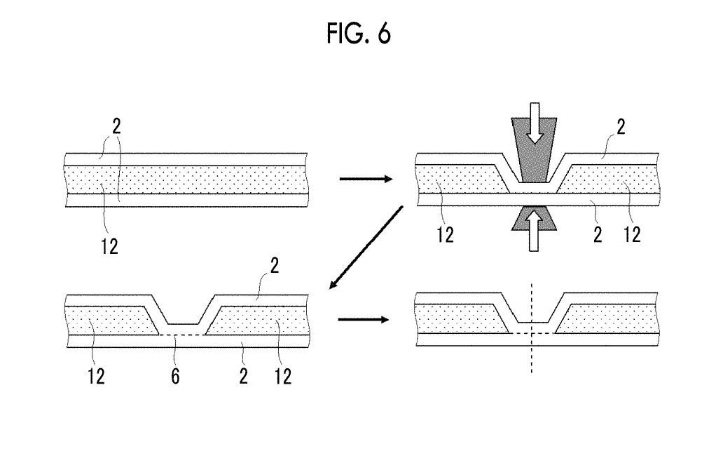

As a preferred method for manufacturing the wavelength conversion film 1 of the present invention, a method for obtaining a sheet-shaped wavelength conversion film is exemplified as follows. As shown in FIG. 6, a pair of base materials 2 are used. A wavelength conversion layer 12 (or an uncured state thereof, that is, a polymerizable composition) is laminated on one base material 2 and the wavelength conversion layer 12 is sealed with the other base material 2. Then, the wavelength conversion layer 12 (or polymerizable composition) is squeezed out from a region which becomes a welded portion 6 by applying pressure on the region from upper and lower sides and the region which becomes the welded portion 6 is heated to form the welded portion 6. Thereafter, the center (broken line) of the welded portion 6 is cut.

According to this method, it is possible to easily obtain a structure in which the space between the base materials 2 sandwiching the wavelength conversion layer 12 therebetween is filled with the wavelength conversion layer 12. In this structure, there is no involvement of voids, and therefore, the structure is preferable not only from the viewpoint of appearance but also from the viewpoint of preventing occurrence of cohesive fracture of the welded portion 6 or the wavelength conversion layer 12 starting from the voids.

Furthermore, in this manufacturing method, the wavelength conversion film can be continuously produced through a roll-to-roll method, and therefore, the manufacturing method is preferable from the viewpoint of excellent productivity.

In addition, this manufacturing method is also preferable from the viewpoints in which, after the wavelength conversion layer 12 is sealed once, the wavelength conversion layer 12 can be subjected to wafer processing while maintaining airtightness without exposing the wavelength conversion layer 12 to outside air again, and infiltration of oxygen or vapor into the wavelength conversion layer 12 can be reduced from the stage of the manufacturing process.

In FIG. 6, a schematic view in which the welded portion is one-dimensionally formed and cut is shown, but the welded portion may be two-dimensionally provided. For example, a welded portion may be formed and cut into a box shape to obtain a rectangular wavelength conversion film. In addition, welding and cutting may be performed using laser welding and cutting instead of performing contact type heating or contact type cutting with a blade.

In addition, it is also possible to employ, for example, a method for injecting a wavelength conversion layer (or a precursor thereof) into a structure obtained by folding a base material in advance and molding the base material into a bag shape using a welded portion to seal an opening portion through welding or the like, and a method for removing a wavelength conversion layer continuously formed on a base material from only a region which becomes a welded portion through various methods, and then, forming the welded portion by sealing the wavelength conversion layer with another base material. At this time, a filler may be separately used to fill a gap between the pair of base materials and the wavelength conversion layer so as to fill the gap generated between the wavelength conversion layer and the base materials. As the filler, various well-known adhesives and sealants can be applied.

[Other Constituent Materials]

Other constituent members can be provided to the wavelength conversion film of the present invention as necessary in addition to the above-described constituent members. Examples of the constituent member to be provided include optical functional layers such as a prism layer, a light scattering layer, an anti-Newton ring layer, a color filter layer, a light shielding layer, a wavelength selective reflection layer, a polarized light transmission layer, and a birefringent layer, and structure reinforcing members such as a frame, an aggregate, or a strut, heat insulating materials, and heat conducting materials.

<Backlight Device>

The wavelength conversion film of the present invention can be suitably used in various backlight devices. A typical example of the backlight devices includes a backlight device constituted of various optical members including a light source, a housing, and a wavelength conversion film. The wavelength conversion film of the present invention can be particularly used in a backlight device for a liquid crystal display device (LCD). Examples of the typical backlight device for a liquid crystal display device include direct type and edge light type backlight devices. There is no restriction as long as the wavelength conversion film of the present invention is provided on a path from a light source to a light emitting surface of the backlight device, and a backlight device having any configuration and shape can be provided at any position.

A light emitting diode (LED), a cold cathode fluorescent lamp, a laser, organic EL, and the like can be used as a light source. It is preferable to use LED and a laser as light sources from the viewpoint of effectively exhibiting the wavelength conversion characteristics of the present invention.

### EXAMPLES

Hereinafter, the present invention will be described in detail using examples.

[Production of Support A]

An undercoat layer and a vapor barrier layer were sequentially formed on one surface side of a polyethylene terephthalate (PET) film (trade name “COSMOSHINE (registered trademark) A4300” with a thickness of 50 μm manufactured by TOYOBO Co., LTD.) through the following procedure to manufacture a support A.

(Formation of Undercoat Layer)

Trimethylolpropane triacrylate (product name “TMPTA” manufactured by DAICEL-ALLNEX LTD.) and a photopolymerization initiator (trade name “ESACURE (registered trademark) KT046” manufactured by Lambeth) were prepared and weighed so as to have a mass ratio of 95:5. The mixture was dissolved in methyl ethyl ketone to obtain a coating solution having a concentration of a solid content of 15%. This coating solution was applied on a PET film through a roll-to-roll method using a die coater and passed through a drying zone at 50° C. for 3 minutes. Thereafter, ultraviolet rays were radiated (at a cumulative irradiation dose of about 600 mJ/cm²) in a nitrogen atmosphere, cured by ultraviolet rays, and wound. The thickness of the undercoat layer formed on the PET film was 1 μm.

(Formation of Vapor Barrier Layer)

Next, an inorganic layer (silicon nitride layer) was formed as a vapor barrier layer on the undercoat layer using a roll-to-roll type CVD device.

Silane gas (at a flow rate of 160 sccm), ammonia gas (at a flow rate of 370 sccm), hydrogen gas (at a flow rate of 590 sccm), and nitrogen gas (at a flow rate of 240 sccm) were used as raw material gases in a case of forming the vapor barrier layer. A high frequency power source with a frequency of 13.56 MHz was used as a power source. The film formation pressure was 40 Pa and the arrival film thickness was 50 nm.

The vapor permeability of the support A thus produced was 5.4×g/(m²·day).

### Example 1

(Formation of First Organic Layer (Production of Base Material A))

A butenediol-polyvinyl alcohol copolymer (product name “Nichigo G-polymer OKS-1083” manufactured by Nippon Synthetic Chemical Industry Co., Ltd.) was dissolved in water to obtain a coating solution having a concentration of a solid content of 10%. This coating solution was applied on a support A through a roll-to-roll method using a die coater and passed through a drying zone at 80° C. for 10 minutes to form a first organic layer having a thickness of 10 μm on the support A, and a base material A to be used in a wavelength conversion film was produced.

(Formation of Wavelength Conversion Layer)

<Preparation of Polymerizable Composition and Production of Coating Solution>

The following polymerizable composition 1 was prepared and filtered with a polypropylene filter having a pore diameter of 0.2 μm. Then, the filtrate was dried for 30 minutes under reduced pressure and used as a coating solution.

—Polymerizable Composition 1—
Toluene dispersion liquid (with light emission maximum of 520 nm) of quantum dot 1 20 parts by mass
Toluene dispersion liquid (with light emission maximum of 630 nm) of quantum dot 2 2 parts by mass
Monomer 1 (lauryl methacrylate) 94.2 parts by mass
Cross-linking agent (1,9-nonane diacrylate) 5 parts by mass
Irgacure 819 (polymerization initiator) 0.2 parts by mass

The quantum dot concentration of the toluene dispersion liquid of the quantum dot 1 and the quantum dot 2 is 3 mass %.

The quantum dot 1 (CZ520-100 manufactured by NN-LABS, LLC) is a core-shell type quantum dot having a core of CdSe and a shell of ZnS, and has an emission center wavelength of 520 nm and a half-width of 30 nm.

Octadecylamine is coordinated with the quantum dot 1 as a ligand.

The quantum dot 2 (CZ620-100 manufactured by NN-LABS, LLC) is a core-shell type quantum dot having a core of CdSe and a shell of ZnS, and has an emission center wavelength of 630 nm and a half-width of 35 nm.

Octadecylamine is coordinated with the quantum dot 2 as a ligand.

(Manufacture of Wavelength Conversion Film of Example 1)

A polymerizable composition 1 (coating solution) was applied on the surface of the first organic layer of the base material A using a die coater while continuously conveying the base material A prepared above at a speed of 1 m/min with a tension of 60 N/m to form a coating film having a thickness of 50 μm. Next, the base material A on which the coating film was formed was wound around a backup roller, and the other base material A was laminated on the coating film in a direction in which the first organic layer came in contact with the coating film to form a laminate.

Thereafter, pressurized thermal fusion was performed so that a welded portion having a width of 5 mm is formed in a lattice form while continuously sandwiching this laminate using a pair of heat rollers for forming a seal portion. The obtained laminate was irradiated with ultraviolet rays while further continuously conveying the laminate.

The diameter of the backup roller was ϕ300 mm and the temperature of the backup roller was 50° C. The irradiation amount of the ultraviolet rays was 2,000 mJ/cm². In addition, the welded portion had an average width of 5 mm and the wavelength conversion layer region partitioned by the welded portion was 1925×1205 mm.

The coating film was cured by being irradiated with ultraviolet rays.

The obtained laminate was cut at the center of the welded portion to obtain a wavelength conversion film of Example 1.

The fused portion of the obtained wavelength conversion film was formed to have a width of 2.5 mm on each side and the wavelength conversion layer was 1920×1200 mm. The thickness at the center of the wavelength conversion layer was 50 μm±2 μm on an average of 10 sheets. End portions of the wavelength conversion film were visually observed. Voids were not recognized in the end portions in the whole film which had a structure in which the entirety of the region sandwiched between the two base materials A was filled with the wavelength conversion layer.

### Example 2

(Formation of Second Organic Layer)

Polyvinylidene chloride (product name “SARAN RESIN R204” manufactured by Asahi Kasei Corporation) was dissolved in a 2:1 mixed solvent of tetrahydrofuran and toluene to obtain a coating solution having a concentration of a solid content of 15%.

This coating solution was applied on a support A (vapor barrier layer) through a roll-to-roll method using a die coater, and then passed through a drying zone at 60° C. for 10 minutes to form a second organic layer having a thickness of 15 μm on the support A.

(Formation of First Organic Layer (Production of Base Material B))

A butenediol-polyvinyl alcohol copolymer (product name “Nichigo G-polymer OKS-1083” manufactured by Nippon Synthetic Chemical Industry Co., Ltd.) was dissolved in water to obtain a coating solution having a concentration of a solid content of 10%. This coating solution was applied on the second organic layer, which has been previously formed, through a roll-to-roll method using a die coater and passed through a drying zone at 80° C. for 10 minutes to form a first organic layer having a thickness of 5 μm on the second organic layer, and a base material B to be used in a wavelength conversion film was produced.

(Formation of Wavelength Conversion Layer and Production of Wavelength Conversion Film of Example 2)

A wavelength conversion layer was formed on the base material B (first organic layer) in the same manner as in Example 1, and a wavelength conversion film of Example 2 was further manufactured in the same manner as in Example 1.

### Comparative Example 1

A base material C in which only the second organic layer was formed on the support A was produced in the same manner as in Example 2 except that the first organic layer was not formed on the support A, a wavelength conversion layer was formed on the base material C (second organic layer) in the same manner as in Example 1, and a wavelength conversion film of Comparative Example 1 was further manufactured in the same manner as in Example 1.

[Evaluation Method]

(Measurement of Film Thickness of First Organic Layer and Second Organic Layer at End Portions of Wavelength Conversion Film and Measurement of Oxygen Permeability and Vapor Permeability)

The oxygen permeability of the first organic layer and the vapor permeability of the second organic layer at the sealed end portions were calculated from the oxygen permeability and the vapor permeability of each layer measured in a similar single film having a thickness of 100 μm in inverse proportion to the film thickness.

The film thicknesses of the first organic layer and the second organic layer were measured by observing the cross sections of the end portions of the wavelength conversion film with an optical microscope. The results are shown in Table 1.

(Measurement of Luminance)

A commercially available tablet terminal (trade name “Kindle (registered trademark) Fire HDX 7” manufactured by Amazon, hereinafter, simply referred to as “Kindle Fire HDX 7” in some cases) equipped with a blue light source in a backlight unit was decomposed and the backlight unit was taken out. A wavelength conversion film of examples or comparative example was incorporated therein instead of quantum Dot enhancement film (QDEF) of Kindle Fire HDX 7. In this manner, a liquid crystal display device was produced.

The produced liquid crystal display device was turned on so that the whole surface became a white display, and the luminances of the center portion and at a position (end portion) of 5 mm from the cut end portion were measured using a luminance meter (trade name “SR3” manufactured by TOPCON) provided at a position of 520 mm in the direction perpendicular to the surface of a light guide plate.

(Thermal Durability of Luminance)

The produced wavelength conversion film was heated at 85° C. for 1,000 hours using a precision incubator (DF411 manufactured by YAMATO SCIENTIFIC CO., LTD.) Thereafter, the wavelength conversion film was incorporated into Kindle Fire HDX 7 in the same manner as described above, and the luminances of the center portion and at the position (end portion) of 5 mm from the cut end portion were similarly measured.

The thermal durability of the luminances was evaluated based on the following evaluation criteria. The results are shown in Table 1.

<Evaluation Criteria>

A: Decrease in luminance after heating is less than 10%

B: Decrease in luminance after heating is greater than or equal to 10% and less than 20%

C: Decrease in luminance after heating is greater than or equal to 20% and less than 30%

D: Decrease in luminance after heating is greater than or equal to 30%

(Moisture-Heat Durability of Luminance)

The produced wavelength conversion film was heated at a temperature of 60° C. and a relative humidity of 90% RH for 1,000 hours using a precision incubator (DF411 manufactured by YAMATO SCIENTIFIC CO., LTD.) Thereafter, the wavelength conversion film was incorporated into Kindle Fire HDX 7 in the same manner as described above, and the luminances of the center portion and at the position (end portion) of 5 mm from the cut end portion were similarly measured.

The moisture-heat durability of the luminances was evaluated based on the following evaluation criteria. The results are shown in Table 1.

<Evaluation Criteria>

A: Decrease in luminance after moist heat treatment is less than 10%

B: Decrease in luminance after moist heat treatment is greater than or equal to 10% and less than 20%

C: Decrease in luminance after moist heat treatment is greater than or equal to 20% and less than 30%

D: Decrease in luminance after moist heat treatment is greater than or equal to 30%

TABLE 1

| | Wavelength | | End portion | | | | Evaluation of durability | | | |
|---|---|---|---|---|---|---|---|---|---|---|
| | conversion | Support | First organic layer | | Second organic layer | | Center portion | | End portion | |
| | layer (QD | Vapor | | Oxygen | | Vapor | Heat | Moisture- | Heat | Moisture- |
| | layer) | permeability | | permeability | Thick- | perme- | durability | heat dura- | durability | heat dura- |
| | Thickness | [g/(m² · | Thickness | [cc/(m² · | ness | ability | of | bility of | of | bility of |
| | [μm] | day)] | [μm] | day · atm)] | [μm] | [g/(m² · day)] | luminance | luminance | luminance | luminance |
| Example 1 | 50 | 5.4 × 10⁻⁴ | 10 | 0.01 | — | — | A | B | A | B |
| Example 2 | 50 | 5.4 × 10⁻⁴ | 5 | 0.02 | 15 | 12 | A | A | A | A |
| Comparative | 50 | 5.4 × 10⁻⁴ | — | — | 10 | 18 | A | B | C | B |
| Example 1 | | | | | | | | | | |

It was found that, even under the long-term durability test conditions in which the wavelength conversion film of Comparative Example 1 was deteriorated, the performance of the wavelength conversion layer in the vicinity of the end portions of the wavelength conversion films of Examples 1 and 2 can be favorably maintained and a wavelength conversion film having excellent reliability can be provided by the present invention.

The present invention can be suitably used for various optical applications such as a backlight device for a liquid crystal display device.

### EXPLANATION OF REFERENCES

1: wavelength conversion film
2: base material
3: support
4: first organic layer
5: outer region in surface direction of wavelength conversion layer
6: region in which base materials are welded to each other (welded portion)
7: resin layer
8: vapor barrier layer
9: innermost position of region in which base materials are welded to each other in surface direction of wavelength conversion layer
12: wavelength conversion layer
13: quantum dot
14: matrix
T1: thickness of first organic layer in region in which base materials are welded to each other
T2: thickness of first organic layer in region of main surface of base materials

What is claimed is:

1. A wavelength conversion film comprising:
a wavelength conversion layer and base materials sandwiching the wavelength conversion layer therebetween; and
a welded portion in which the base materials are welded to each other on an outer side in a surface direction of the wavelength conversion layer,
wherein the base materials have a support having a vapor permeability less than or equal to 10 g/(m²·day) and a first organic layer, which is formed on one surface side of the support and formed of polyvinyl alcohol or a polyvinyl alcohol copolymer, and have the wavelength conversion layer sandwiched therebetween while the support faces outward.

2. The wavelength conversion film according to claim 1,
wherein the base materials have a second organic layer having a vapor permeability less than or equal to 30 g/(m²·day), and
wherein the support, the second organic layer, and the first organic layer are laminated in this order.

3. The wavelength conversion film according to claim 1,
wherein the support includes a vapor barrier layer having a vapor permeability less than or equal to 10 g/(m²·day).

4. The wavelength conversion film according to claim 1,
wherein an oxygen permeability of the first organic layer is less than or equal to 10 cc/(m²·day·atm) at the innermost position of the welded portion in the surface direction of the wavelength conversion layer.

5. The wavelength conversion film according to claim 3,
wherein the vapor permeability of the vapor barrier layer is less than or equal to 30 g/(m²·day) at the innermost position of the welded portion in the surface direction of the wavelength conversion layer.

6. The wavelength conversion film according to claim 1,
wherein a thickness of the first organic layer in a region of the welded portion is less than or equal to 50% of the thickness of the first organic layer in a region of a main surface.

7. The wavelength conversion film according to claim 1,
wherein a space between the base materials sandwiching the wavelength conversion layer therebetween is filled with the wavelength conversion layer.
